(19) United States
(12) Patent Application Publication
(10) Pub. No.: US 2006/0146182 A1
(43) Pub. Date: Jul. 6, 2006

(54) Wavelet image-encoding method and corresponding decoding method

(75) Inventors: Sebastien Brangoulo, Rennes (FR); Patrick Gioia, Cesson Sevigne (FR); Nathalie Laurent, Vignoc (FR)

Correspondence Address: SHEWCHUK IP SERVICES, 533 77TH STREET WEST, EAGAN, MN, 55121, US

(73) Assignee: France Telecom, Paris (FR)

(21) Appl. No.: 10/539,429

(22) PCT Filed: Dec. 19, 2003
(86) PCT No.: PCT/FR03/03846

§ 371 Date: Nov. 4, 2005

(30) Foreign Application Priority Data
Dec. 20, 2002 (FR) 02/1602

(51) Int. Cl. H04N 11/04; H04N 7/12; H04N 11/02

(52) U.S. Cl. 348/397.1; 348/400.1; 348/401.1

(57) ABSTRACT

A method and apparatus are provided for encoding an image having a hierarchical mesh associated therewith, comprising the wavelet encoding of said mesh. One such encoding method involves the use of at least two types of wavelets which are applied selectively to different areas of the image.

The field of the invention is that of the encoding of still or moving images and especially, but not exclusively, the encoding of successive images of a video sequence. More specifically, the invention relates to an image-encoding/decoding technique in which an image has a mesh associated with it and which implements a method known as a wavelet method. The invention can be applied more particularly but not exclusively to second-generation wavelets, presented especially in the document by Wim Sweldens, “The Lifting Scheme: A Construction of Second-Generation Wavelets”, SIAM Journal on Mathematical Analysis, Volume 29, number 2, pp 511-546, 1998.

The development of new transmission networks (xDSL, mobile telephones using GPRS and UMTS, etc.), means that image encoding and digital video compression techniques must adapt to the heterogeneity of networks as well as to possible fluctuations in quality of service (QoS) over time. Taking all these factors into account in the encoding of still or moving images must give the final user optimum visual quality.

To date, there are several known image-encoding techniques, such as techniques of encoding by time-based prediction and discrete cosine transformation based on a block structure, such as the techniques proposed by the ISO/MPEG (“International Organization for Standardization/Moving Picture Coding Expert Group”) and/or ITU-T (“International Telecommunication Union-Telecommunication Standardization Sector”).

There also exist prior art proprietary encoding techniques based on encoding by block-based DCT transform (Microsoft with Windows Media, RealMedia with Real One, Divx (registered marks), etc.), or again certain wavelet-encoding or mesh-encoding techniques, as presented especially in the French patent applications No. 2 781 907 “Procédé de codage d'un maillage source tenant compte des discontinuités, et applications correspondantes” (Method for the encoding of a source mesh taking account of discontinuities, and corresponding applications) and No. 2 825 855 “Procédés et dispositifs de codage et de décodage d'images mettant en oeuvre des maillages emboîtés, programme, signal et application correspondantes” (Methods and devices for the encoding and decoding of images implementing nested images, corresponding program, signal and application) filed on behalf of the holder of the present patent application.

However, these different prior art image-encoding techniques have many drawbacks, especially for applications or transmission networks using very low bit rates.

Thus, block-based encoding techniques lead to the appearance of strong effects, or artefacts, which greatly reduce the visual quality of the restitution of the image. MPEG-4 or ITU-T/H.263 type encoding is now considered to have reached its limits, especially because of the fixed-size rigid block structure, used as a medium for all the encoding computations and operations. Similarly, for techniques implementing wavelets, an over-oscillation effect, also known as “ringing”, gives a fuzzy rendering, as well as the impression of “seeing” the wavelet on the image, which is very unpleasant for the user.

For applications or transmission networks using higher bit rates, these different techniques cannot be used to attain the limits of encoding efficiency.

Finally, none of these prior art techniques can be used to optimize the encoding of an image, in taking account of the intrinsic characteristics of this image.

Furthermore, in the context of the encoding of video sequences, and with a view to reducing the volume of the data transmitted and encoded, it is common practice to compute an error image, for instance by the subtraction of an original image from the sequence and of an interpolated image, or an image determined by motion estimation/compensation. Reference can be made for example to the French patent application No. 00 10917 entitled “Procédé de construction d'au moins une image interpolée entre deux images d'une séquence animée, procédés de codage et de décodage, signal et support de données correspondants” (Method for the construction of at least one image interpolated between two images of a moving sequence, corresponding methods of encoding and decoding, signal and data carrier” filed on behalf of the holder of the present patent application.

Now none of these prior art encoding techniques is adapted to the specific content of such error images, which generally contain only high frequencies, such as contours, textures, or again singularities.

The invention is aimed especially at overcoming these drawbacks of the prior art.

More specifically, it is a goal of the invention to provide a technique for the encoding of still or moving images that optimizes the result of the encoding as compared with the prior art techniques.

It is another goal of the invention to implement a technique of this kind that enables a reduction in the volume of the data coming from the encoding, and hence possibly transmitted by a communications network up to the image decoding and restitution device.

It is also a goal of the invention to implement a technique of this kind that is “scalable”, i.e. that adapts to fluctuations of the transmission networks, and especially to variations in the bit rate of such networks.

It is also a goal of the invention to provide a technique of this kind that enables low-bit-rate transmission of the information for the encoding of an image or sequence of images.

It is another goal of the invention to implement such a technique that enables the attaining of high visual quality for the restitution of the encoded image, and especially the zones of discontinuity of this image.

It is also a goal of the invention to provide a technique of this kind that is well suited to the encoding of error images.

It is yet another goal of the invention to provide a technique of this kind that is simple and costs little to implement.

These goals, as well as others that shall appear here below, are achieved by means of a method for encoding an image with which a hierarchical mesh is associated, implementing a wavelet encoding of said mesh.

According to the invention, said encoding method implements at least two types of wavelets applied selectively to distinct zones of said image.

Thus, the invention relies on an entirely novel and inventive approach to the encoding of still or moving images, especially the encoding of images of video sequence. Indeed, the invention proposes not only to encode images according to the innovative wavelet technique, using especially second-generation wavelets such as those introduced by W. Dahmen (“Decomposition of refinable spaces and applications to operator equations”, Numer. Algor., No. 5, 1993, pp. 229-245,) and J. M. Carnicer, W. Dahmen and J. M. Pena (“Local decomposition of refinable spaces”, Appl. Comp. Harm. Anal. 3, 1996, pp. 127-153,), but also to optimize said encoding through the application of different types of wavelets to distinct zones of the image.

Indeed, the inventors of the present patent application have highlighted the fact that the different types of existing wavelets have distinct encoding properties. They therefore had the idea of exploiting these different properties by the application, to the different zones of an image, of the type of wavelets whose encoding properties are best suited to the content of each of the zones.

Thus, the total encoding of the image is optimized, in adapting the wavelet encoding to regions of the image having different characteristics and through the use, if necessary, of several types of distinct wavelets for the encoding of a same image.

Preferably, an encoding method of this kind comprises the following steps:
a step for partitioning said image into at least two zones of distinct natures, the nature of each zone being a function of at least one characteristic parameter of said mesh in said zone;
for each of said zones, a step for the assigning, at least as a function of said nature, of a type of wavelet enabling the optimizing of said encoding of said mesh of said zone.

It will be understood, of course, that if the image should be homogenous, in the sense that all the zones of this image are of the same nature, the image is not partitioned but the entire image is directly assigned the type of wavelets by which the encoding of the image in its totality can be optimized.

Advantageously, said characteristic parameter of said mesh takes account of the density of said mesh in said zone.

Indeed, the density of the mesh at a point of the zone, and in a region encompassing this point, makes it possible for example to determine whether the zone considered is a texture, contour, or singularity zone as shall be described in greater detail hereinafter in this document.

According to an advantageous characteristic of the invention, said nature of said zone belongs to the group comprising:
at least one type of texture;
at least one type of contour;
at least one type of singularity;
at least one type of color;
at least one type of shape.

According to a preferred characteristic of the invention, said types of wavelets belong to the group comprising:
the Loop wavelets;
the Butterfly wavelets;
the Catmull-Clark wavelets;
the affine wavelets.

Those skilled in the art will easily understand that the invention is not limited to the above-mentioned types of wavelets, which are presented purely by way of an illustration.

Advantageously, for each of said zones, an encoding method of this kind comprises a step for the application, to said mesh, of coefficients of said type of wavelets assigned to said zone, taking account of a scalar value associated with said mesh at an updating point of said zone and of said scalar value associated with said mesh at least at certain points neighboring said updating point.

Preferably, said scalar value represents a parameter of said mesh belonging to the group comprising:
the luminance of said mesh;
at least one chrominance component of said mesh.

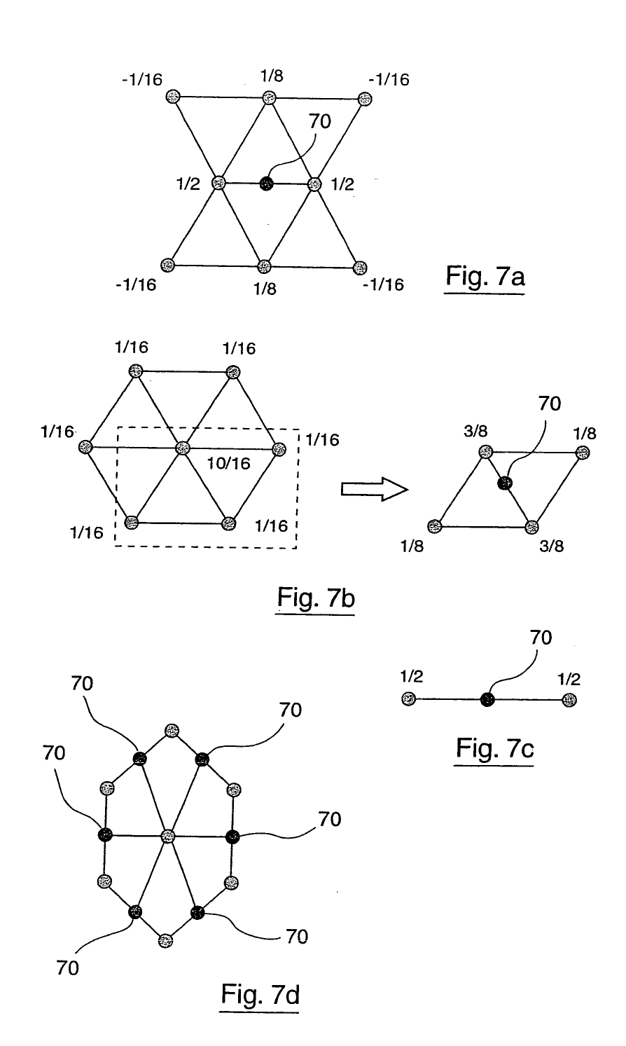

Thus a position is taken, for example, at the point of application of the mesh (or updating point), and a component of the chrominance at this point is considered. The value of this same chrominance component is then studied at the points neighboring this updating point, to apply the wavelet coefficients accordingly (by weighting), as is presented in greater detail here below with reference to FIGS. 7a to 7d.

Preferably, an encoding method of this kind furthermore comprises a step for encoding said wavelet coefficients implementing a technique belonging to the group comprising:
a zero-tree type technique;
an EBCOT type technique.

Advantageously, with said image belonging to a sequence of successive images, said method furthermore comprises a step to compare said wavelet coefficients of said image with the wavelet coefficients of at least one image preceding or following said image in said sequence, so as to avoid the implementation of said encoding step for wavelet coefficients of said image identical to those of said preceding or following image.

Thus, the volume of the transmitted data is reduced. This is particularly advantageous in the case of transmission networks working at low bit rates or for low-capacity restitution terminals. For the wavelet coefficients identical to the coefficients previously transmitted for another image, it is enough to transmit a set of zeros, as well as a reference enabling an indication of where the wavelet coefficients can be found (for example a reference to the previous image for which these coefficients have already been received by the decoding device).

Advantageously, an encoding method of this kind enables the encoding of a sequence of successive images, and said image is an error image, obtained by comparison of an original image of said sequence and of an image built by motion estimation/compensation, said image comprising at least one error region to be encoded and, as the case may be, at least one substantially empty region.

Naturally, should the original image be absolutely identical to the estimated image, the error image is empty, and therefore does not comprise any error region to be encoded. Inversely, if the original image differs in every point from the estimated image, the error image does not comprise any empty region.

Preferably, said partitioning step comprises a step for the detection of said error regions of said image by thresholding, making it possible to determine at least one region of said image having an error greater than a predetermined threshold.

This threshold may be parameterized according to constraints of the application or the transmission network considered, or again as a function of the quality of restitution to be obtained.

According to a first advantageous alternative embodiment of the invention, said partitioning step also comprises a step for the grouping together of at least certain of said detected error regions in parallelepiped-shaped blocks.

Preferably, said partitioning step comprises a step for creating said zones of said image in the form of sets of blocks of a same nature.

Thus, a same wavelet processing is applied to all the blocks of a same nature even if these blocks are distant from one another within the image.

According to a second advantageous alternative embodiment of the invention, said partitioning step comprises a step for the creation of said zones of said image from said detected error regions, implementing a quadtree type technique.

The invention also relates to a method for decoding an image with which a wavelet-encoded hierarchical mesh is associated, implementing a selective decoding of distinct zones of said image as a function of information on the type of wavelets assigned to the encoding of the mesh of each of said zones.

Thus, the image having been partitioned during the encoding into at least two zones of distinct natures, and the nature of a zone being a function of at least one characteristic parameter of said mesh in said zone, the decoding method of the invention comprises the following steps:
a step for the extraction, from a stream representing the encoded image, of information on the type of wavelets assigned to the encoding of the mesh of each of the zones;
for each of the zones, a step for the decoding, as function of such information, of the mesh of the zone.

The invention also relates to a device for encoding an image with which a wavelet-encoded hierarchical mesh is associated, implementing means for the wavelet-encoding of said mesh and comprising means for the selective application of at least two types of wavelets to distinct zones of said image.

The encoding device of the invention therefore comprises the following means:
means for partitioning the image into at least two zones of distinct natures, the nature of a zone being a function of at least one characteristic parameter of the mesh in the zone;
means, implemented for each of the zones, for the assigning, as a function of the nature of the zone, of at least one type of wavelet enabling the optimizing of said encoding of said mesh of said zone.

The invention also relates to a device for decoding an image with which a wavelet-encoded hierarchical mesh is associated, comprising means for a selective decoding of distinct zones of said image as a function of information on the type of wavelets assigned to the encoding of the mesh of each of said zones.

The image having been partitioned during the encoding into at least two zones of distinct natures, and the nature of a zone being a function of at least one characteristic parameter of the mesh in the zone, the decoding method of the invention therefore comprises the following means:
means for the extraction, from a stream representing the encoded image, of information on the type of wavelets assigned to the encoding of the mesh of each of the zones;
for each of the zones, means for the decoding, as a function of the information, of the mesh of the zone.

The invention also relates to a signal representing an image with which there is associated a wavelet-encoded hierarchical mesh. According to the invention, with at least two types of wavelets having been applied selectively to distinct zones of said image during the encoding, a signal of this kind conveys information on said type of wavelets assigned to the encoding of the mesh of each of said zones.

The image having been partitioned during the encoding into at least two zones of distinct natures, and the nature of a zone being a function of at least one characteristic parameter of the mesh in the zone, the signal of the invention therefore conveys information on a type of wavelet assigned to the encoding of the mesh of each of the zones.

Advantageously, such a signal is structured in the form of packets each associated with one of said zones of said image, each of said packets comprising the following fields:
a field indicating the start of a packet;
a field conveying an identifier of said packet;
an information header field;
a field comprising said pieces of information on said type of wavelets assigned to said zone;
a field comprising wavelet coefficients applied to said mesh of said zone;
a field relating to the form of said mesh of said image;
a field indicating an end of a packet.

Preferably, said information header field comprises:
a sub-field relating to the number of wavelet coefficients of said zone;
a sub-field indicating said zone of said image, as a function of said form of said mesh;
a sub-field relating to the number of bitmaps implemented for said wavelet coefficients.

The method also relates to the application of the encoding method and the decoding method described here above to at least one of the fields belonging to the group comprising:
video streaming;
video storage;
video conferencing;
video on demand;
video mail.

Other features and advantages of the invention shall appear more clearly from the following description of a preferred embodiment, given by way of a simple, illustrative and non-restrictive example, and from the appended drawings, of which:

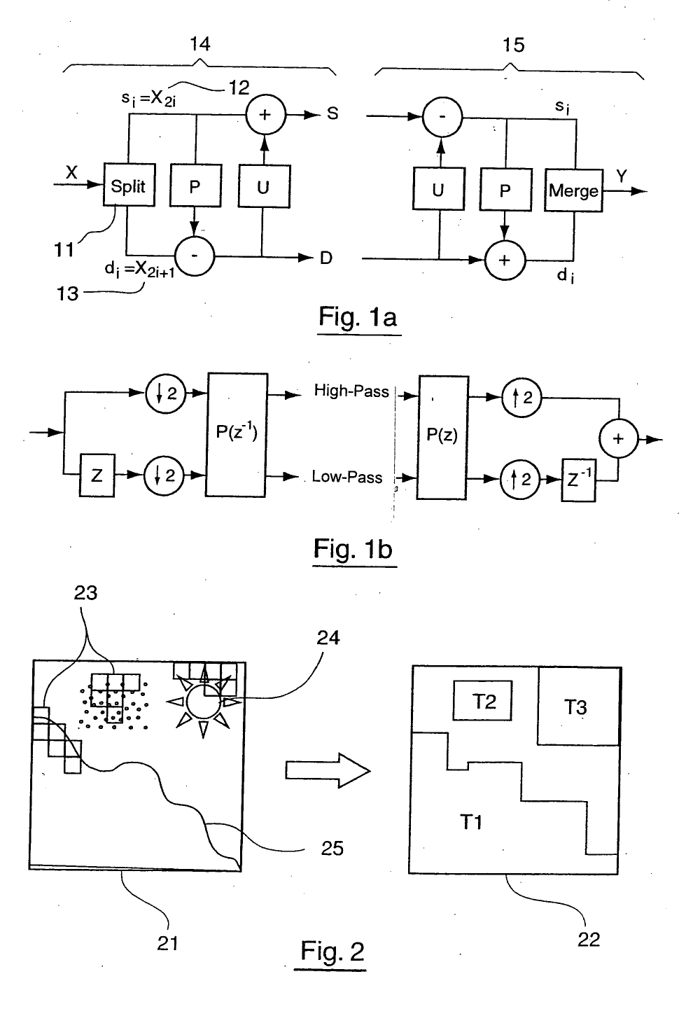

FIGS. 1a and 1b recall the general schemes of lifting decomposition, as described especially by W. Sweldens “The Lifting Scheme: A New Philosophy in Bi Orthogonal Wavelets Constructions”, Proc. SPIE 2529, 1995, pp 68-69;

FIG. 2 illustrates the general principle of the invention relying on the choice of wavelet transformations adapted to the characteristics of different zones of an image;

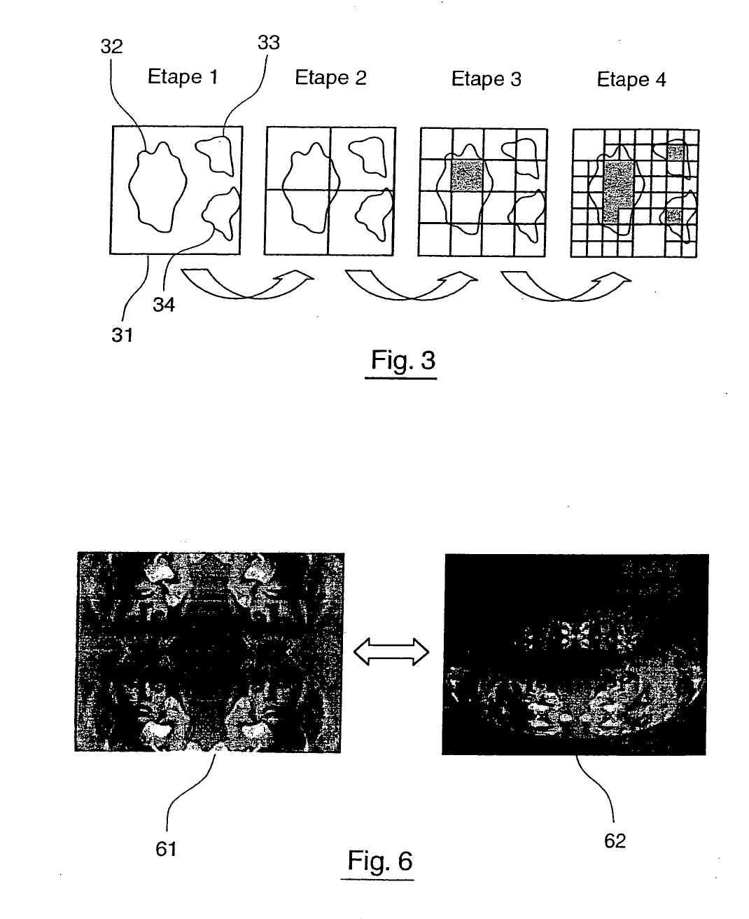

FIG. 3 describes the principle of partitioning the image of FIG. 2 into different zones according to a quadtree type of technique, when the image is an error image;

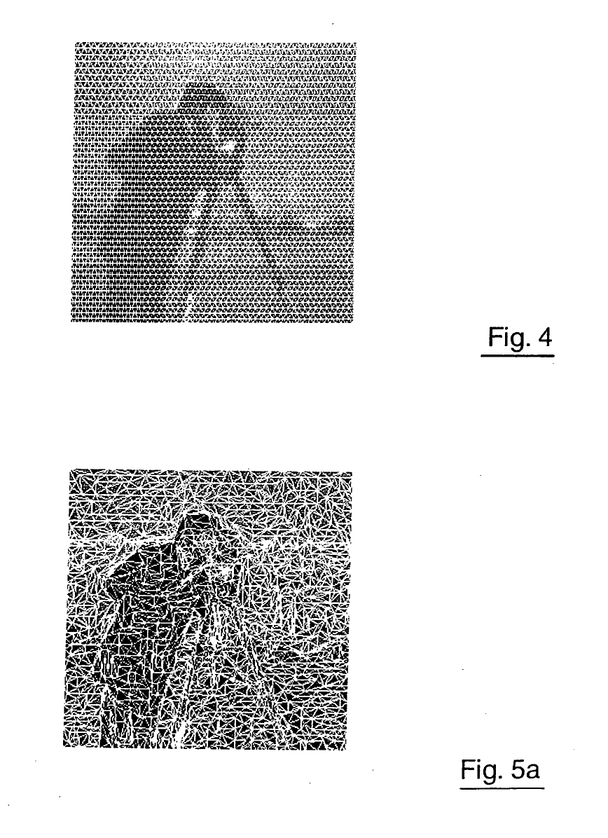

FIG. 4 exemplifies a regular dense mesh applied to an image according to the invention;

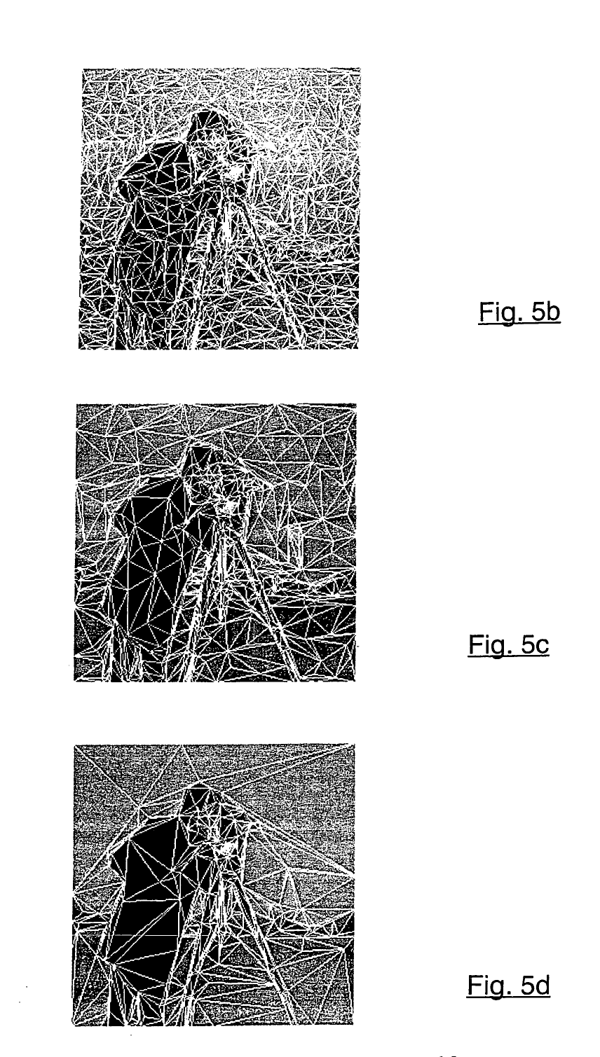

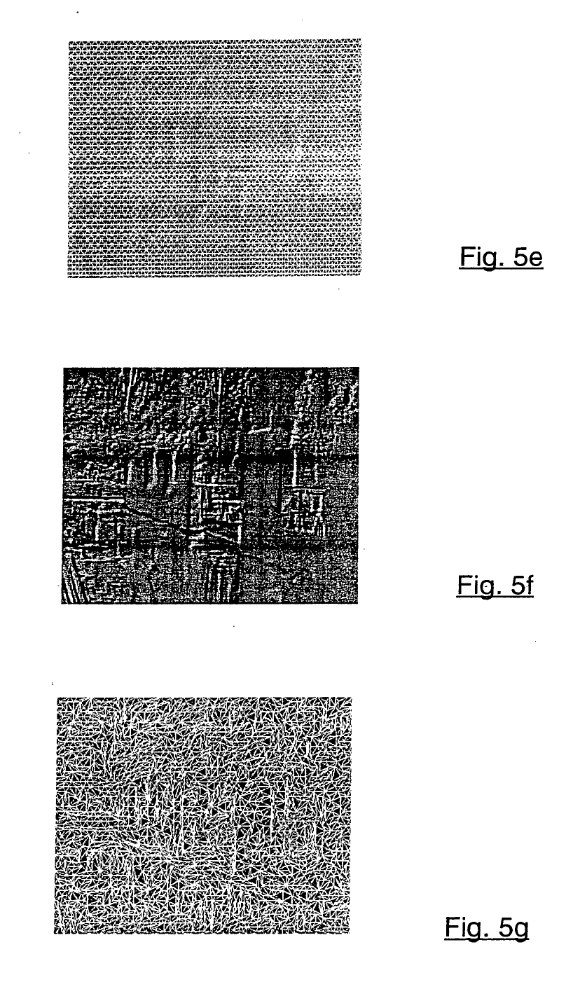

FIGS. 5a to 5g illustrate different steps of subdivision of the mesh of an image implemented in the framework of the invention;

FIG. 6 presents the principle of management of the edges in the framework of the invention;

FIGS. 7a to 7d illustrate the different wavelets schemes which may be applied to the different zones of an image according to the invention.

The general principle of the invention is based on the application of different types of wavelets, and especially second-generation wavelets, to different regions of an image, so as to optimize the general encoding of the image, by choosing wavelets of a type whose encoding properties are suited to the content of the zone considered.

Prior to the detailed description of an embodiment of the invention, a few brief reminders shall be made on video encoding as well as the concepts of meshing, lifting and second-generation wavelets. Indeed, the invention may be implemented especially in the general context of the encoding of a video sequence, based on these different concepts.

The general principle of video encoding, which is described for example in the document ISO/IEC (ITU-T SG8) JTC1/SC29 WG1 (JPEG/JBIG), JPEG2000 Part I Final Committee Draft, Document N1646R, March 2000 consists in describing a digital video in the form of a succession of images represented in the YUV plane (Luminance/Chrominance r/Chrominance b), sampled in various ways (4:4:4/4:2:2/4:2:0 . . . ). The encoding system consists in changing this representation in taking account of the space and time redundancies in the successive images. Hence transformations (of a DCT or wavelet type for example) are applied to obtain a series of interdependent images.

These images are “ordered” in the I/B/P order, where each type of image has well-determined properties. The I images, also called “intra” images, are encoded in the same way as still images and serve as references for the other images of the sequence. The P images, also called “predicted” images, contain two types of information: a piece of motion-compensated error information and the motion vectors. These two pieces of information are deduced from one or more preceding images which may be of the I, or P type. The B images too, which are also called “bidirectional” images, contain these two pieces of information, but are based on two references, namely a rear reference and a front references which may be of the I type or P type.

This means that it is enough to transmit the classically encoded intra image “I” and then the motion vector and the errors pertaining to each successive image, to be able to restore the totality of the video sequence considered.

The known techniques for the encoding of still images or video sequences also rely on the use of hierarchical meshes that are associated with the images to be encoded. Thus, let us consider a still image, for example one encoded in gray levels. The image may be considered to be a discretized representation of a parametrical surface. It is therefore possible to apply any mesh either to a zone of the image or to the entire image. Using hierarchical subdivision (which may or may not be adaptive), this mesh is made to evolve regularly or irregularly. Thus, a “hierarchy” is available through the subdividing of the mesh solely in the regions of the image where the computed error is above a predetermined threshold. A general view of the basic techniques of meshes is also presented in the document ISO/IEC (ITU-T SG8) JTC1/SC29 WG1 (JPEG/JBIG), JPEG2000 Part I Final Committee Draft, Document N1646R, March 2000.

Certain image encoding techniques also rely on a wavelet decomposition method known as “lifting”, described especially by W. Sweldens “The Lifting Scheme : A New Philosophy in Bi-Orthogonal Wavelets Constructions”, Proc. SPIE 2529, 1995, pp 68-69. Lifting has appeared very recently and is becoming prevalent as a method of wavelet decomposition that is simpler and faster than the usual, convoluted method. It enables simple reconstruction, by simple row/column operations, on the matrix of analysis.

Referring to FIGS. 1a and 1b, the general schemes of “lifting” decomposition, as well as the form of the associated polyphase matrix are now considered.

The general method consists in separating 11 the signal into two even-valued 12 and odd-valued 13 samples and in predicting the odd-valued samples as a function of the even-valued samples. Once the prediction has been made, an updating of the signal is performed in order to preserve its initial properties. This algorithm may be repeated as many times as desired. Representation by lifting leads to the concept of the polyphase matrix, enabling the analysis 14 and the synthesis 15 of the signal.

FIG. 1b more specifically illustrates the “lifting” scheme concatenated with the polyphase matrix P(z) such that:

$$P ( z ) = [ \begin{matrix}A & 0 \\ 0 & B\end{matrix} ] {\prod }_{i = n}^{I} [ \begin{matrix}1 & {s}_{i} ( z ) \\ 0 & 1\end{matrix} ] [ \begin{matrix}1 & 0 \\ {t}_{i} ( z ) & 1\end{matrix} ]$$

$$and$$

$${P}^{- 1} ( z ) = {\prod }_{i = 1}^{n} [ \begin{matrix}1 & 0 \\ - {t}_{i} ( z ) & 1\end{matrix} ] [ \begin{matrix}1 & - {s}_{i} ( z ) \\ 0 & 1\end{matrix} ] [ \begin{matrix}1 / A & 0 \\ 0 & 1 / B\end{matrix} ]$$

with sᵢ(z) and tᵢ(z) being two Laurent polynomials and A and B being standardization coefficients

It may be recalled finally that the second-generation wavelets, which may be implemented especially in the context of the present invention, constitute a novel transformation, coming from the world of mathematics.

This transformation was introduced first by W. Dahmen (“Decomposition of refinable spaces and applications to operator equations”, Numer. Algor., N^{o}5, 1993, pp. 229-245) and J. M. Carnicer, W. Dahmen and J. M. Pena (“Local decomposition of refinable spaces”, Appl. Comp. Harm. Anal. 3, 1996, pp. 127-153), then developed by W. Sweldens (“The Lifting Scheme: A Construction of Second Generation Wavelets”, November 1996, SIAM Journal on Mathematical Analysis) and W. Sweldens & P. Schröder (“Building Your Own Wavelet at Home”, Chapter 2, Technical report 1995, Industrial Mathematics Initiative).

The wavelets are built from an irregular subdivision of the space of analysis, and are based on a method of averaged and weighted interpolation. The vector product commonly used in L²(R) becomes a weighted internal vector product. These wavelets are particularly well suited to analysis on compact supports and on intervals. However, they keep the properties of the first-generation wavelets, namely good time/frequency localization and high computation speed, because they are built around the lifting method described here above.

M. Lounsbery, T. DeRose, and J. Warren in “Multiresolution Analysis for Surfaces of Arbitrary Topological Type”, ACM Transactions on Graphics, 1994 have envisaged the application of these wavelets to any surface structure. In the present invention, these wavelets are applied to a mesh, which constitutes a surface whose topology may be any topology.

To define these second-generation wavelets with precision, we may first of all recall the properties that these wavelets have in common with what are called first-generation wavelets, then indicate the additional properties that the second-generation wavelets show and that are exploited especially in the context of the present invention.

Properties common to first-generation and second-generation wavelets:
P1: the wavelets form a Riez basis on L₂(R), as well as a “uniform” basis for a great variety of spaces of functions such as the Lebesgue, Lipchitz, Sobolev and Besov spaces. This means that any functions of the spaces cited may be decomposed on a wavelet basis, and this decomposition will converge uniformly as a norm (the norm of the initial space) toward this function.
P2: the coefficients of decomposition on the uniform basis are known (or may be found simply). Either the wavelets are orthogonal or the dual wavelets are known (in the bi-orthogonal case).
P3: the wavelets, as well as their dual wavelets, have properties that are local in space and in frequency. Certain wavelets even have a compact support (the present invention uses such wavelets preferably but not exclusively). The properties of frequency localization result directly from the regularity of the wavelets (for the high frequencies) and the number of zero polynomial moments (for the low frequencies).
P4: the wavelets may be used in multiresolution analysis. This leads to the FWT (Fast Wavelet transform) by which it is possible to pass from the function to the wavelet coefficients in “linear time”.
   Additional properties characterizing second-generation wavelets:
Q1: while the first-generation wavelets provide bases for functions defined on Rⁿ, certain applications (data segmentation, solutions of partial differential equations in general domains, or application of the wavelets on a mesh with arbitrary topology etc. necessitate wavelets defined on arbitrary domains of Rⁿ, such as curves, surfaces or varieties;
Q2: the diagonalizing of the differential forms, the analysis of curves and surfaces, and the weighted approximations necessitate a base adapted to the weighted measurements. However, the first-generation wavelets provide bases only for spaces with invariant measurements by translation (typically the Lebesgue measurements);
Q3 : Many real problems necessitate algorithms adapted to data with irregular sampling, while the first-generation wavelets enable analysis on the sampled data to be performed only regularly.

Thus, to summarize the construction of the second-generation wavelets, the following principles may be emphasized.

During multiresolution analysis, it is assumed that the traditional space in which the scale functions evolve are the values Vₖ, such that:

$$\overline{{⋃}_{k} {V}_{k}} = {L}_{2} ( ℜ )$$

The space of analysis is enlarged, in taking position in a Banach space (Ref B). We therefore have, for the second-generation wavelets:

$$\overline{{⋃}_{k} {V}_{k}} = B$$

A scalar product is defined, in the Banach space, taken in the sense of the distributions, enabling the redefinition of the dual spaces. The refinement condition becomes (in matrix form):
φ^{k-1}=Pφ^{k}

where P is any unspecified matrix.

After these few reminders of the concepts necessary for the understanding of the video encoding techniques, a more detailed description shall now be given of the general principle of the invention with reference to FIG. 2.

We shall consider the image referenced 21, which may be a still image or one of the images of a video sequence that is to be encoded. A hierarchical mesh referenced 23 is associated with it. In FIG. 2, this mesh is a regular mesh that only partially overlaps the image 21. The mesh may, of course, also be an irregular mesh and/or overlap the totality of the image 21.

The general principle of the invention consists of the identifying, within the image 21, of the zones of different natures, to which it is chosen to apply distinct types of wavelets, whose properties are well suited to the content of the zone considered. Thus, it is possible to partition the image 21 of FIG. 2, into a plurality of zones 22, respectively referenced T1, T2 and T3.

To the extent possible, the zones referenced T1, T2 and T3 are built in the form of rectangular blocks, to facilitate their processing, or in sets of agglomerated rectangular blocks.

Thus, the zone referenced T3 of the set 22, which corresponds to the sun 24 of the image 21, is a rectangle encompassing the sun 24. However, the zone referenced T1, which corresponds to the irregular relief 25 of the image 21, has a staircase shapes that corresponds to a set of parallelepiped blocks following the shapes of the relief 25 as closely as possible.

The zone T1 is a texture zone of the image 21, while the zone T2 encompasses the isolated singularities of the image 21, and the sun of the zone T3 is chiefly defined by contours.

According to the invention, therefore, the type of wavelets that most closely corresponds to the encoding of each of these zones is chosen. In one particular embodiment of the invention, for the texture zone T1, it will thus be chosen to apply a Butterfly type of wavelet while the singularity zones T2 and contour zones T3 will preferably be encoded respectively by means of affine wavelets and Loop wavelets.

In this way, it is possible to optimize both the encoding of the image 21 and its quality of restitution on an adapted terminal.

The following table summarizes the preferred criteria of choice according to the invention, of different types of wavelets as a function of the nature of the zone to be encoded.

| Type of | Nature of | |
|---|---|---|
| wavelet | the zone | Justification |
| Butterfly | Texture | Interpolating and non-polynomial wavelet. |
| | | It is C¹ piecewise (derivable and with |
| | | continuous derivative) on the regular |
| | | zones. It drops to become C¹ on the |
| | | vertices of the basic mesh. It is therefore |
| | | better suited to the isolated high |
| | | frequencies (hence the textures) |
| Loop | Contours | Approximating, polynomial wavelet in the |
| | | regular zones. It is C² (twice derivable, |
| | | and with continuous second derivative). It |
| | | complies with the curvature, and in the |
| | | event of a drop to become C², it remains |
| | | C¹ (thus ensuring compliance with the |
| | | curvature). It is therefore suited to |
| | | contours and, more particularly to natural |
| | | objects. |
| Catmull-Clark | Contours | Same type of wavelet as the Loop wavelet, |
| | | more indicated in the case of the contours |
| | | on a non-natural object. The same |
| | | justification as in the case of the Loop |
| | | wavelets applies to the contours |
| Affine | Singularities | Very short wavelet, C⁰, that enables |
| | | very fast adapting to a point without need |
| | | for encoding around this point. It adapts |
| | | perfectly well to the case of the |
| | | singularities. |

Other types of wavelets may of course also be implemented within the framework of the invention, which is in no way restricted solely to the types of wavelets and natures of zones described in the above table.

It will be noted that the above table makes a distinction, especially with regard to the contours, between the case of natural objects and that of non-natural objects. Indeed, natural objects are determined by contours that are more uncertain than non-natural objects. Thus, in terms of frequency, natural objects do not have a well-defined peak, unlike non-natural objects. It is therefore necessary to distinguish between the two cases, as a function of the object processed.

One criterion of distinction of these two types of objects may be, for example, obtained by the thresholding of the filtered image by means of a multidirectional high-pass filter applied to the gray levels associated with the contour.

We shall now attempt to present a particular embodiment of the invention in the general context of the encoding of a video sequence, for which one of the particular steps corresponds to the implementation of the invention.

An encoding of this kind relies especially on the video encoding and lifting techniques described here above.

We shall consider a scheme of the I/(n)B/P type, with n as a positive or 0 value, where I designates an “intra” image, B a bi-directional image and P a predicted image. By way of an example, it may be considered that an MPEG, for example an MPEG-4, type of encoding is implemented except for the error images, for which the invention is implemented, with mesh and second-generation wavelet encoding.

It is of course possible to envisage the replacing of the MPEG-4 encoding by any type of encoding based on equivalent techniques, namely techniques using a time-based prediction and a discreet cosine transformation (DCT) based on a block structure, and entropic quantification and encoding operations for the information generated. In particular, an ITU-T/H.264 or MPEG-4 AVC encoding (as described especially in the Joint Final Committee Draft of Joint Video Specification (ITU-T Rec. H.264|ISO/IEC 14496-10 AVC), Thomas Wiegand, Klagenfurt, 22 Jul. 2002) may replace the MPEG-4 encoding, without departing from the context of the present invention.

For each image of the video sequence considered entering into the encoding device, or encoder, this device decides to encode it with an MPEG-4 encoding module (with or without optimization of distortion/bit-rate trade-off), or with a specific encoding module based on a distortion/bit-rate optimization. It may be recalled that optimization of distortion/bit-rate trade-off provides for a compromise between the quality of the image and its size: an algorithm based on the optimization of distortion/bit-rate trade-off therefore provides for optimizing with a view to obtaining the best possible compromise.

Motion estimation for P and B type images is implemented according to the block-matching technique stipulated in the MPEG-4 standard.

As for error encoding, it is achieved by the implementation of the invention. Such a transformation of mesh-based second-generation wavelets into error images leads to a good representation of the discontinuities of the images (contours, texture, singularities etc), at very low associated encoding cost. The invention therefore enables very high efficiency of compression since, firstly, it takes account of the different types of singularity of the images and secondly, it processes these images in choosing an appropriate wavelet module.

The first step of the encoding of the video sequence with which the invention is concerned here relates to the encoding of the intra (I) images. This encoding relies, for example, on the use of a DCT transform as in MPEG-4, or on the application of a first-generation wavelet encoding method, as described for example by W. Dahmen in “Decomposition of refinable spaces and applications to operator equations”, No. Algor., N^{o}5, 1993, pp. 229-245.

As for the second step of the encoding of the video sequence, it relates to the encoding of the predicted images P and of the bidirectional images B. These images are first of all motion-compensated for by a classic method of estimation/compensation such as for example the “block matching” method [described by G. J. Sullivan and R. L. Baker in “Motion compensation for video compression using control grid interpolation”, International Conference on Acoustics, Speech, and Signal Processing, 1991. ICASSP-91, vol. 4, pp 2713-2716”], and then the corresponding error images are stored.

Thus, the error images are obtained by subtraction of the exact image from the sequence and an image constructed by motion compensation/estimation. If this latter differs from the exact image, the error image comprises at least one error region, which has to be encoded. If at least certain parts of the exact image and of the image obtained by motion compensation are identical, the error image also has at least one substantially empty region, for which it is enough to transmit a zero value during the transmission of the encoding stream.

During a third step, the error information and the motion information are separated, and the operation focuses on the detection of the error regions within the error image, through a thresholding operation. If “e” is assumed to be a tolerance threshold, the error regions are recognized as being all the regions of the error image having a value above this threshold.

In a first alternative embodiment of the invention, these error regions are grouped together by blocks (to have quadrilateral zones). The grouping together of the blocks is obtained by the association, with each block, of at least one characteristic corresponding to information on textures, colors, shapes, contours, isolated singularities. This characterizing enables the grouping together of the blocks and the generation of a partitioning of the image, in the form of zones of distinct natures, enabling the encoding of each zone of the partitioning according to its optimum transformation, by application of the appropriate type of wavelet.

In a second alternative embodiment of the invention, illustrated in FIG. 3, the image is partitioned into intra zones of distinct natures according to a “quadtree” type of technique.

We shall consider an image 31, comprising for example three error regions referenced 32 to 34. The operation is performed by successive iterations (step 1 to step 4), in partitioning the image 31 into four square zones, each of these zones being in turn subdivided into four square sub-zones and so on and so forth, until the square mesh thus obtained can be considered to be included in the error regions referenced 32, 33 or 34 of the image 31.

After the detection of the different error blocks of the image has been achieved (according to one of the two alternative embodiments described here above), the image is subdivided into zones of different natures, as illustrated here above with reference to FIG. 2. These images are encoded by means of different wavelets to enable the optimizing of the encoding as a function of the properties of the chosen wavelet.

The nature of a zone may, for example, be determined by the density of the mesh that covers it. Thus, if the mesh of the zone considered is dense, then it can be deduced therefrom that this is a texture zone.

By contrast, a zone comprising singularities of the image is a zone in which the mesh is dense around a dot of the image and then has very little density on the neighboring dots. A contour zone for its part is characterized by a mesh that is dense in one direction.

In a fourth step, after the zones (preferably in the form of quadrilaterals) of distinct natures of the image have been determined, a regular dense mesh is applied to each of the zones, as illustrated by FIG. 4. The density of the mesh is the parameter that can be adjusted as a function of the image. FIG. 4 illustrates a regular mesh applied to an image representing a cameraman. This mesh is of the type having a staggered-row arrangement. It enables an irregular subdivision and the use of second-generation wavelets.

During a fifth step of the processing, and according to a first alternative embodiment, the operation starts with the regular dense mesh of FIG. 4 and makes it evolve toward an “optimal” coarse mesh according to predetermined debit-distortion criteria and as a function of the different properties of the zone of the image considered (texture zone, contours zone, or singularities zone for example).

FIGS. 5a to 5d illustrate the evolution of the mesh of FIG. 4 at the iterations numbers 3, 6, 9 and 16 respectively.

More specifically, after the reading of the image and the creation of the regular mesh of FIG. 4, successive iterations are performed, consisting in the obtaining of an optimization L² of the triangles of the meshes, a merger of the triangles and then a swapping of the ridges. The positions of the nodes of the mesh are then quantified and a geometrical optimization is then implemented. Indeed, it must be verified that no mesh has turned over: each triangle is therefore tested in an operation known as the clockwise operation. A final quantification of the points is necessary. There is then a return to the quantification L². This loop is done as many times as desired, the number of successive iterations constituting a parameter of the encoding that can be personalized.

FIGS. 5e to 5g illustrate this fifth step of the encoding of the video sequences when the image considered is an error image. Thus, FIG. 5e represents an error image extracted from the video sequence known as the Foreman sequence; FIG. 5f represents an error image extracted from the regularly meshed Foreman sequence; finally, FIG. 5g represents an error image extracted from a meshed Foreman sequence after some iterations of the zone search algorithm of the invention.

This fifth step of the encoding of the video sequences can also be implemented according to a second alternative embodiment, in which a “coarse” mesh is applied to the image considered, and then this coarse mesh is refined by successive subdivision. To generate a coarse mesh of this kind, equidistant points are placed on the contours, the textures, and the singularities of the image, which will then enable the zone to be covered to be meshed in a judicious (i.e. adaptive) manner. A standard 1 to 4 subdivision is then performed to obtain the final, semi-regular meshing by refining.

It is possible for example to proceed according to the technique described by P. Gioia in “Reducing the number of wavelet coefficients by geometric partitioning”, Computational Geometry, Theory and Applications Vol. 14, 1999, pp 25-48.

The sixth step of the encoding of the sequence relates to the management of the edges, as illustrated in FIG. 6. To do this, the method uses a homeomorphism of the plane mesh 61 (staggered-row mesh) with a torus 62 (according to a method known as the periodization method) or again a classic symmetrization of the data. For this purpose, the image is extended in inverting the diagonals located on the problematic boundaries (namely on the boundaries that are not oriented in one of the directions of the mesh). The periodization-and-symmetrization approach proves to be important in terms of images because it prevents the skewing of the statistical distribution of the wavelet coefficients to be transmitted and hence enables an attempt to achieve convergence thus towards a bi-exponential law.

In a seventh step, the second-generation wavelets are applied to the mesh of the image. For this purpose, for example, the method proposed by M. Lounsbery, T. DeRose, J. Warren “Multiresolution Analysis for Surfaces of Arbitrary Topological Type”, ACM Transactions on Graphics, 1994 is applied with the types of wavelets selected according to the invention as a function of the nature of the zone considered (for example Loop or Butterfly wavelets).

The wavelet is applied to the mesh in taking account of a scalar value associated with the mesh at the updating point of the zone (which in one particular example may be the center point), but also as a function of this same scalar value at the neighboring points. This scalar value may, for example, be the luminance of the point of the mesh considered, or a component of the chrominance of this same point. There follows a wavelet-weighted decomposition illustrated in FIGS. 7a to 7d.

FIG. 7a illustrates a Butterfly wavelet in which the center point referenced 70 indicates the point of application of the mesh and in which the other points represent the coefficients of interpolation at the neighboring points of the mesh. As indicated here above, this wavelet is particularly suited to the management of textures.

In other words, the characteristic parameters of the mesh (for example the luminance of the image at certain points) are studied in order to determine if it is necessary and/or advantageous to add an additional node referenced 70, according to a step of analysis by second-generation wavelets, as described for example in the article by M. Lounsbery, T. DeRose, and J. Warren referred to here above.

FIGS. 7b to 7d respectively illustrate the Loop, affine, and Catmull-Clark wavelets. In these figures, the point referenced 70 represents the point of application of the mesh, also called the updating point. The other points also represent the coefficients of interpolation on the points neighboring the mesh.

By proceeding in the manner described here above, wavelet coefficients are thus obtained for the particular mesh of the zone of the image considered. This operation is performed on the entire image and, in the case of the video sequences, for all the P/B images. The wavelet best suited to the type of data processed (for example textures, contours, shapes etc) is applied to each part of the mesh.

As indicated here above, in order to determine the nature of the zone concerned, it is possible to work with the density of the mesh about a point and a region about this point. Thus, if at a point A of the image, the mesh is dense (relative to its two successive neighbors) but, around this region, the mesh is empty, it would be said that this is an isolated singularity. An affine wavelet will then be applied for example. If, around this region, the mesh is still dense, it will be said that it is a texture and a Butterfly wavelet will preferably be applied. To characterize the contours, the density of the mesh will be detected along a direction (if the mesh is dense along a particular direction).

In the context of the encoding of a video sequence, the interdependence of the successive images of the sequence is also taken into account: thus, when passing from one image to another, a part of the mesh (or even the entire mesh) may be the same. It is therefore appropriate to make transmission, to the decoding or restitution terminal, of only those nodes of the mesh that have changed relative to the preceding image of the sequence. The other nodes will be considered by the encoder to be fixed. Similarly, the wavelet applied to a particular mesh remains, in most cases, invariant from one image to another. Should the wavelet remain the same, no information is transmitted at this level.

In an eighth step, the previously obtained wavelet coefficients are encoded: to do this, the invention implements a zerotree type of technique (as described for example by J. M Shapiro in “Embedded Image Coding Using Zerotree of Wavelet Coefficients”, IEEE Transactions on Signal Processing, Vol. 41, NO. 12, December 1993, pp 3445-3461 or an EBCOT method (as presented for example by D. Taubman in “High Performance Scalable Image Compression with EBCOT”, IEEE Transactions on Image Processing, Vol. 9, NO. 7, July 2000) to classify and quantify the wavelet coefficients.

The ninth step of the encoding of the video sequence relates to the shaping of these wavelet coefficients. This shaping may be done according to the method proposed in the document ISO/IEC JTC I/SC 29/WG 11, N4973, AFX Verification Model 8, Klagenfurt, Austria, July 2002, concerned by the MPEG4 standardization. Depending on the zones of interest, or the high error zones, packets may be highlighted relative to others during reception and decoding.

Another method consists in transmitting the wavelet coefficients by “order” of priority, depending on the quantity of errors contained in the packets. Thus, the data may be transmitted in the following form: packet number/information header (number of coefficients, the zone of the image, the number of bitmaps etc)/type of wavelet/wavelet coefficients/mesh information. The data are thus transmitted to the channel and then received for decoding or storage.

According to the invention, a signal structure is preferably defined. This signal structure is organized in the form of consecutive packets, each of these packets itself comprising the following fields: start of the packet/Packet N^{o}/Information Header/Types of wavelets/wavelet coefficients/shape of the mesh/end of packet.

The packet number field contains an identifier of the packet that is assigned in the order of the size of the packet.

The information header field comprises the following sub-fields:
the number of wavelet coefficients (total number in the zone of the processed image);
the zone of the image considered (as a function of the information provided especially by the “shape of the mesh” field);
the number of bitmaps (used for the encoding of the wavelet coefficients).

The “type of wavelet” field indicates whether the wavelet applied to the zone considered is, for example, a Loop, Butterfly, Catmull-Clark wavelet, or again an affine wavelet, or any other type chosen according to the nature of the zone considered.

As for the “shape of the mesh” field, it enables the transmission of the basic mesh (in the form of vertices and ridges).

If we consider, for example, an image to be encoded that has been partitioned according to the invention into two zones of distinct natures, the first zone having been encoded by Butterfly wavelets, and the second zone by Loop wavelets, the signal of the invention conveying the transmitted encoded sequence preferably has the form:
Start of image
start of packet/N^{o}145/250 coeff/vertex5, ridge2,4,5; vertex45, ridge56,54,87 . . . /256/butterfly/(10,25,14), (25,54,84),( . . . ),(25,36,10)/end of packet
start of packet/N^{o}260/130 coeff/vertex14, ridge8,41,5; vertex7, ridge21,47,21 . . . /256/loop/(1,5,8), (2,4,42),( . . . ),(52,20,10)/end of packet
End of image

The invention also provides for the association, with each type of wavelet, of a predefined code between the encoder and the decoder, so as to simplify the content of the wavelet type field. Thus, it is possible to consider assigning the identifier 1 to the Loop wavelets, the identifier 2 to the Butterfly wavelets, the identifier 3 to the Catmull-Cark wavelets and the identifier 4 to the affine wavelets. The wavelet type field can then be encoded on 2 bits.

The decoding method is the method that is the dual of the encoding method. On reception of the signal conveying the above packets, the decoding device therefore extracts the information therefrom on the type of wavelets applied to each of the zones defined for the image and applies a selective decoding of each of these zones, as a function of the type of wavelets used during the decoding.

Thus, an image of optimal visual quality is obtained, and this is achieved at low encoding cost.

1. Method for encoding an image with which a hierarchical mesh is associated, implementing a wavelet-encoding of said mesh, wherein said encoding method implements at least two types of wavelets applied selectively to distinct zones of said image.

2. Encoding method according to claim 1 wherein the method comprises:
partitioning said image into at least two zones of distinct natures, the nature of each zone being a function of at least one characteristic parameter of said mesh in said zone;
for each of said zones, assigning, at least as a function of said nature, of a type of wavelet enabling the optimizing of said encoding of said mesh of said zone.

3. Encoding method according to claim 2 wherein said characteristic parameter of said mesh takes account of the density of said mesh in said zone.

4. Encoding method according to claim 2 wherein said nature of said zone belongs to the group comprising:
at least one type of texture;
at least one type of contour;
at least one type of singularity;
at least one type of color; and
at least one type of shape.

5. Encoding method according to claim 1 wherein said wavelet types belong to the group comprising:
Loop wavelets;
Butterfly wavelets;
Catmull-Clark wavelets; and
affine wavelets.

6. Encoding method according to claim 1 wherein the method comprises, for each of said zones, the application to said mesh, of coefficients of said type of wavelets assigned to said zone, taking account of a scalar value associated with said mesh at an updating point of said zone and said scalar value associated with said mesh at certain points at least, neighboring said updating point.

7. Encoding method according to claim 6, wherein said scalar value represents a parameter of said mesh belonging to the group comprising:
the luminance of said mesh; and
at least one chrominance component of said mesh.

8. Encoding method according to claim 6, wherein the method furthermore comprises encoding said wavelet coefficients implementing a technique belonging to the group comprising:
a zero-tree type technique; and
an EBCOT type technique.

9. Encoding method according to claim 6 wherein, with said image belonging to a sequence of successive images, said method furthermore comprises comparing said wavelet coefficients of said image with the wavelet coefficients of at least one image preceding or following said image in said sequence, so as to avoid the implementation of said encoding step for wavelet coefficients of said image identical to those of said preceding or following image.

10. Encoding method according to claim 1 wherein the method enables the encoding of a sequence of successive images, and said image is an error image, obtained by comparison of an original image of said sequence and an image built by motion estimation/compensation, said image comprising at least one error region to be encoded and at least one of any existing substantially empty region.

11. Encoding method according to claim 10 wherein said partitioning step comprises detecting said error regions of said image by thresholding, making it possible to determine at least one region of said image having an error greater than a predetermined threshold.

12. Encoding method according to claim 11 wherein said partitioning step also comprises grouping together of at least certain of said detected error regions in parallelepiped-shaped blocks.

13. Encoding method according to claim 12 wherein said partitioning step comprises creating said zones of said image in the form of sets of blocks of a same nature.

14. Encoding method according to claim 11 wherein said partitioning step comprises creating said zones of said image from said detected error regions, implementing a quadtree type technique.

15. Method for decoding an image with which a wavelet-encoded hierarchical mesh is associated, wherein the method implements a selective decoding of distinct zones of said image as a function of information on the type of wavelets assigned to the encoding of the mesh of each of said zones.

16. Device for decoding an image with which a wavelet-encoded hierarchical mesh is associated, wherein the device comprises:
means for the wavelet-encoding of said mesh; and
means for the selective application of at least two types of wavelets to distinct zones of said image.

17. Device for decoding an image with which a wavelet-encoded hierarchical mesh is associated, wherein the device comprises means for the selective decoding of distinct zones of said image as a function of information on a type of wavelet assigned to the encoding of the mesh of each of said zones.

18. Signal representing an image with which there is associated a wavelet-encoded hierarchical mesh, wherein at least two types of wavelets having been applied selectively to distinct zones of said image during encoding of the hierarchical mesh, and wherein said signal conveys information on said type of wavelets assigned to the encoding of the mesh of each of said zones.

19. Signal according to claim 18, wherein the signal is structured in the form of packets each associated with one of said zones of said image, each of said packets comprising the following fields:
a field indicating the start of a packet;
a field conveying an identifier of said packet;
an information header field;
a field comprising said pieces of information on said type of wavelets assigned to said zone;
a field comprising wavelet coefficients applied to said mesh of said zone;
a field relating to the form of said mesh of said image;
a field indicating an end of a packet.

20. Signal according to claim 19 wherein said information header field comprises:
a sub-field on the number of wavelet coefficients of said zones;
a sub-field indicating said zone of said image, as a function of said form of said mesh; and
a sub-field on the number of bitmaps implemented for said wavelet coefficients.

21. Encoding method according to claim 1 and further comprising application of the method to at least one of the fields belonging to the group comprising:
video streaming;
video storage;
video conferencing;
video on demand; and
video mail.

22. Decoding method according to claim 15 and further comprising application of the method to at least one of the fields belonging to the group comprising:
video streaming;
video storage;
video conferencing;
video on demand; and
video mail.
